(19) United States
(12) Patent Application Publication
(10) Pub. No.: US 2021/0033181 A1
(43) Pub. Date: Feb. 4, 2021

(54) DIFFERENTIAL DEVICE

(71) Applicant: MUSASHI SEIMITSU INDUSTRY CO., LTD., TOYOHASHI-SHI, AICHI (JP)

(72) Inventor: Hirohisa ODA, TOYOHASHI-SHI, AICHI (JP)

(21) Appl. No.: 17/041,202

(22) PCT Filed: Mar. 20, 2019
(86) PCT No.: PCT/JP2019/011738

§ 371 Date: Sep. 24, 2020

(30) Foreign Application Priority Data
Mar. 29, 2018 (JP) 2018-064508

(51) Int. Cl. F16H 48/08; F16H 48/40

(52) U.S. Cl. CPC F16H 48/08; F16H 57/0483; F16H 48/40

(57) ABSTRACT

A differential device is provided in which a differential case is dividedly formed into a pair of case half bodies, wherein the differential case is dividedly formed into a pair of case half bodies that are joined to each other in a state in which open ends thereof oppose each other in an axial direction, an inner peripheral face of at least one case half body is formed by turning while a rotational axis of a material to be machined is made to coincide with the rotational axis, and the one case half body has a wall part in which the position of an outside face thereof is determined so that an oil hole extending between an interior and an exterior of the one case half body is formed by the turning. In such differential device, the oil hole of the case half body is formed without an additional process.

### TECHNICAL FIELD

The present invention relates to a differential device, and in particular to one that includes a hollow differential case that is capable of rotating around a first axis, a differential mechanism that is housed within the differential case, lubricating oil introduction means that is capable of introducing lubricating oil from outside into the differential case, and a ring gear that is joined to a flange part on an outer periphery of the differential case and meshes with a drive gear connected to a power source, the differential mechanism having a pinion shaft that is disposed on a second axis orthogonal to the first axis and is supported on the differential case, a pinion gear that is rotatably supported on the pinion shaft, and a pair of side gears that mesh with the pinion gear and are capable of rotating around the first axis.

In the present invention and the present specification, the ‘axial direction’ means the axial direction of the differential case (that is, a direction along the first axis), the ‘radial direction’ means a radial direction of the differential case (that is, the direction of a radius of a circle having the first axis as a center line), and the ‘peripheral direction’ means a peripheral direction of the differential case (that is, the direction of the circumference of a circle having the first axis as a center line).

### BACKGROUND ART

An arrangement in which the differential case of the differential device is dividedly formed from a pair of case half bodies joined to each other with open end faces thereof as mating faces is already known, as disclosed in for example Patent Document 1.

### PRIOR ART DOCUMENTS

### Patent Documents

Patent Document 1: Japanese Patent Application Laid-open No. 54-38027

### SUMMARY OF THE INVENTION

### Problems to be Solved by the Invention

In the above differential device, since in a state in which the pair of case half bodies dividedly forming the differential case are separated, a differential mechanism can be assembled or an inner face of the differential case can be subjected to machining, there is no inherent necessity for providing the differential case with a large working window that enables the above operations. Therefore, in the differential device described in Patent Document 1 also, the differential case is not provided with a large working window.

In such a differential device, due to the differential case not having a large window hole there is an advantage in terms of ensuring the rigidity of the differential case, but on the other hand it becomes difficult to smoothly discharge lubricating oil that has been introduced into the differential case, the lubricating oil is degraded quickly, and there is a possibility that problems such as seizure of the differential mechanism will occur.

When a large window hole is added to a split-type differential case in order to solve the above problems, not only is the rigidity of the differential case degraded, but there is also the problem that the cost will increase by a portion corresponding to the addition of a window hole.

The present invention has been proposed in light of the above circumstances, and it is an object thereof to provide a differential device that can solve the above problems of a conventional device with a simple structure.

### Means for Solving the Problems

In order to attain the above object, according to a first aspect of the present invention, there is provided a differential device comprising a hollow differential case that is capable of rotating around a first axis, a differential mechanism that is housed within the differential case, lubricating oil introduction means that is capable of introducing lubricating oil from outside into the differential case, and a ring gear that is joined to a flange part on an outer periphery of the differential case and meshes with a drive gear connected to a power source, the differential mechanism having a pinion shaft that is disposed on a second axis orthogonal to the first axis and is supported on the differential case, a pinion gear that is capable of rotating around the pinion shaft, and a pair of side gears that mesh with the pinion gear and are capable of rotating around the first axis, characterized in that the differential case comprises a pair of case half bodies that are joined to each other in a state in which open ends thereof oppose each other in an axial direction, an inner peripheral face of at least one case half body is formed by turning while a rotational axis of a material to be machined is made to coincide with the first axis, and the one case half body has a wall part in which the position of an outside face thereof is determined so that an oil hole extending between the interior and the exterior of the one case half body is formed by the turning.

Further, according to a second aspect of the present invention, there is provided a differential device comprising a hollow differential case that is capable of rotating around a first axis, a differential mechanism that is housed within the differential case, lubricating oil introduction means that is capable of introducing lubricating oil from outside into the differential case, and a ring gear that is joined to a flange part on an outer periphery of the differential case and meshes with a drive gear connected to a power source, the differential mechanism having a pinion shaft that is disposed on a second axis orthogonal to the first axis and is supported on the differential case, a pinion gear that is capable of rotating around the pinion shaft, and a pair of side gears that mesh with the pinion gear and are capable of rotating around the first axis, characterized in that the differential case comprises a pair of case half bodies that are joined to each other in a state in which open ends thereof oppose each other in an axial direction, an inner peripheral face of at least one case half body is formed by turning while a rotational axis of a material to be machined is made to coincide with the first axis, the one case half body comprises a pair of first wall parts that each have a pinion shaft insertion support part having opposite end parts of the pinion shaft inserted into and supported thereon, and a second wall part that is positioned between the pair of first wall parts in a peripheral direction, with regard to the first wall part and the second wall part, at the same position in the axial direction where inner peripheral faces thereof are successively subjected to the turning, a radial distance from the rotational axis up to an outside face of the second wall part is set to be shorter than a radial distance from the rotational axis up to an inner peripheral face of the first wall part, and an oil hole is formed by the turning so as to extend through part of the second wall part, the oil hole providing communication between an interior and an exterior of the one case half body.

Furthermore, according to a third aspect of the present invention, in addition to the second aspect, the inner peripheral face of the first wall part is formed by the turning into a spherical shape in which a maximum diameter part is biased further inward in the axial direction than an open end in the axial direction of the first wall part, the flange part and the pinion shaft insertion support part are disposed at positions that overlap the maximum diameter part when viewed on a projection plane orthogonal to the second axis, and the oil hole is disposed so as to be adjacent to the flange part on the outer side in an axial direction.

Moreover, according to a fourth aspect of the present invention, in addition to the second or third aspect, the pinion shaft insertion support part is formed from a groove part that is recessed in a mating face of the one case half body that is mated with the other case half body, and sandwiches the pinion shaft between the pinion shaft insertion support part and the other case half body with a clearance in the axial direction, and the pinion shaft is engaged with an inner peripheral part of the ring gear joined to the flange part so as to be capable of transmitting torque.

Further, according to a fifth aspect of the present invention, in addition to any one of the second to fourth aspects, with regard to the second wall part, the outside face is a plane substantially parallel to the pinion shaft.

Furthermore, according to a sixth aspect of the present invention, in addition to any one of the second to fourth aspects, with regard to the second wall part, the outside face extends so as to be curved into an arc shape in the peripheral direction, a plurality of oil holes extending between an interior and an exterior of the second wall part and arranged in the peripheral direction are formed by the turning in the second wall part, and a plurality of reinforcing ribs disposed between adjacent oil holes are provided integrally with the second wall part.

In the present invention, an ‘outside face’ of a wall part (a second wall part) means a side face, facing radially outward, of the wall part (second wall part).

### Effects of the Invention

In accordance with the first and second aspects, part of the oil that has been introduced into the differential case by means of the lubricating oil introduction means and that has lubricated the differential mechanism is discharged outside the differential case by means of centrifugal force via the oil hole formed in the one case half body by turning. This enables lubricating oil within the differential case to be smoothly discharged outside the differential case even without specially providing the differential case with a large window, and since oil that lubricates the differential mechanism can be made to flow efficiently between the interior and the exterior of the differential case, this can contribute to prevention of seizure of parts of the differential mechanism. Moreover, since the oil hole as a lubricating oil discharge path is automatically formed in a specific wall part of the case half body (a second wall part in the second aspect) accompanying turning of the inner face of the case half body, it is totally unnecessary to carry out an additional process for specially providing the oil hole, and this greatly contributes to reduction of the cost.

Moreover, in accordance with the third aspect, since the inner peripheral face of the first wall part having the pinion shaft insertion support part is formed by the turning into a spherical shape in which a maximum diameter part is biased further inward in the axial direction than an open end in the axial direction of the first wall part, the pinion shaft insertion support part and the flange part of the differential case are disposed at positions that overlap the maximum diameter part when viewed on a projection plane orthogonal to the second axis, and the oil hole is disposed so as to be adjacent to the flange part on the outer side in the axial direction, this enables the oil hole to be disposed in a part relatively close to the maximum diameter part of the inner peripheral face of the first wall part, thus enabling oil to be efficiently discharged from the oil hole by means of centrifugal force. Furthermore, even if the oil hole is present relatively close to the maximum diameter part it is possible to form the oil hole so as to extend through the case half body without problems and without interfering with the flange part.

Furthermore, in accordance with the fourth aspect, since the pinion shaft insertion support part is formed from a groove part that is recessed in a mating face of the one case half body that is mated with the other case half body, and sandwiches the pinion shaft between itself and the other case half body with a clearance in the axial direction, and the pinion shaft is engaged with an inner peripheral part of the ring gear joined to the flange part so as to be capable of transmitting torque, this eliminates the necessity for subjecting the one case half body to a process of forming a hole or making a groove a complicated shape in order to provide a pinion shaft insertion support part, thus contributing to reduction of the cost.

Moreover, in accordance with the fifth aspect, since the outside face of the second wall part is a plane substantially parallel to the pinion shaft, it is possible to form with good balance the oil hole in each of the pair of second wall parts, which have the outside face substantially parallel to the pinion shaft, and oil is discharged via the oil hole with good balance.

Furthermore, in accordance with the sixth aspect, since the outside face of the second wall part extends so as to be curved into an arc shape in the peripheral direction, and the plurality of oil holes extending between the interior and the exterior of the second wall part and arranged in the peripheral direction are formed by the turning in the second wall part, and the plurality of reinforcing ribs disposed between adjacent oil holes are provided integrally with the second wall part, due to the plurality of oil holes being disposed in the peripheral direction in a dispersed manner, lubricating oil can be discharged more smoothly, and even when the plurality of oil holes are arranged side by side in this way, degradation of strength caused thereby can be suppressed effectively by means of the reinforcing ribs.

### BRIEF DESCRIPTION OF DRAWINGS

FIG. 1 is a vertical sectional view (a sectional view along line 1-1 in FIG. 2) showing a differential device related to a first embodiment of the present invention and peripheral equipment thereof. (first embodiment)

FIG. 2 is a right side view of the differential device with illustration of a transmission case, an axle, a bearing and a gear of a differential mechanism omitted. (first embodiment)

FIG. 3 is a right side view (a view corresponding to FIG. 2) of the differential device showing the differential case on its own. (first embodiment)

FIG. 4 (a) is a vertical sectional view (a sectional view along line 4(a)-4(a) in FIG. 3) showing a second case half body on its own immediately after machining is completed and FIG. 4 (b) is a vertical sectional view (a view corresponding to FIG. 4 (a)) of a case half body material on its own before the second case half body is machined. (first embodiment)

FIG. 5 is a perspective view when a first case half body on its own is viewed from a mating face f1 side. (first embodiment)

FIG. 6 is a perspective view when the second case half body and a pinion washer are viewed from a mating face f2 side. (first embodiment)

FIG. 7 is a perspective view when the differential case is viewed from the second case half body side in a state in which illustration of the differential mechanism is omitted. (first embodiment)

FIG. 8 is an enlarged sectional view along line 8-8 in FIG. 1. (first embodiment)

FIG. 9 is an enlarged sectional view along line 9-9 in FIG. 1. (first embodiment)

FIG. 10 shows a second embodiment of the present invention and is a perspective view (a view corresponding to FIG. 7) of a differential case when viewed from a second case half body side in a state in which a differential mechanism is omitted. (second embodiment)

FIG. 11 is a right side view (a view corresponding to FIG. 3) of a differential device related to the second embodiment showing the differential case on its own. (second embodiment)

### EXPLANATION OF REFERENCE NUMERALS AND SYMBOLS

A Predetermined axial region of second case half body (the one case half body)
C Differential case
C1 First case half body (the other case half body)
C2, C2′ Second case half body (the one case half body)
C2i Inner peripheral face of second case half body (the one case half body)
Cf Flange part
Ci Inner face of differential case
Ci_{MAX} Maximum diameter part
D Differential device
M Second case half body material (material to be machined)
R Ring gear
X1, X2 First and second axes
W1, W1′ First wall part
W2, W2′ Second wall part (wall part)
ws, ws′ Outside face
8 Drive gear
15, 16 Helical groove (lubricating oil introduction means)
20 Differential mechanism
21 Pinion shaft
22 Pinion gear
23 Side gear
41b Clearance in axial direction
43 Groove part (pinion shaft insertion support part)
61, 71 Oil hole
72 Reinforcing rib

### MODES FOR CARRYING OUT THE INVENTION

Embodiments of the present invention are explained below by reference to the attached drawings.

### First Embodiment

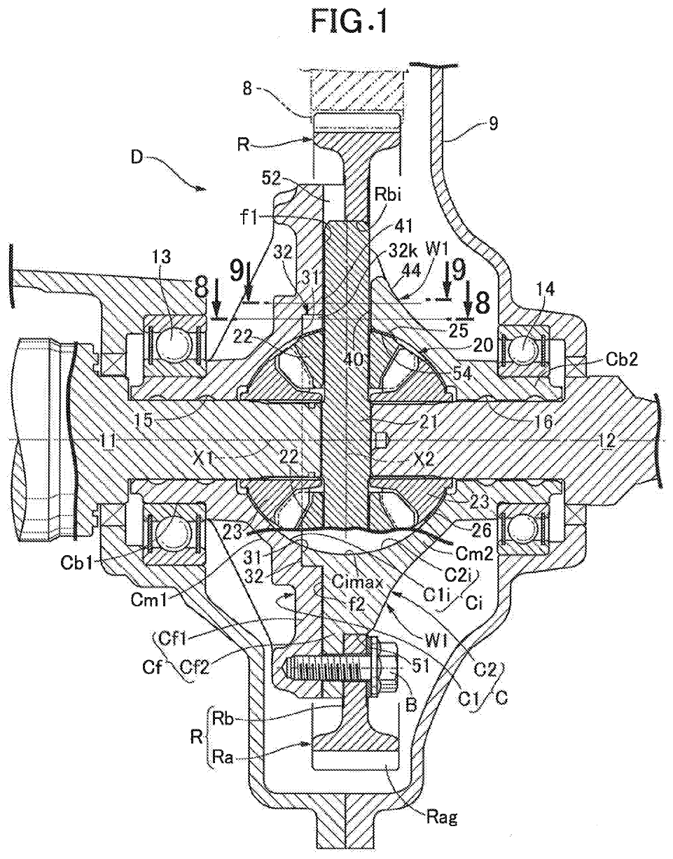

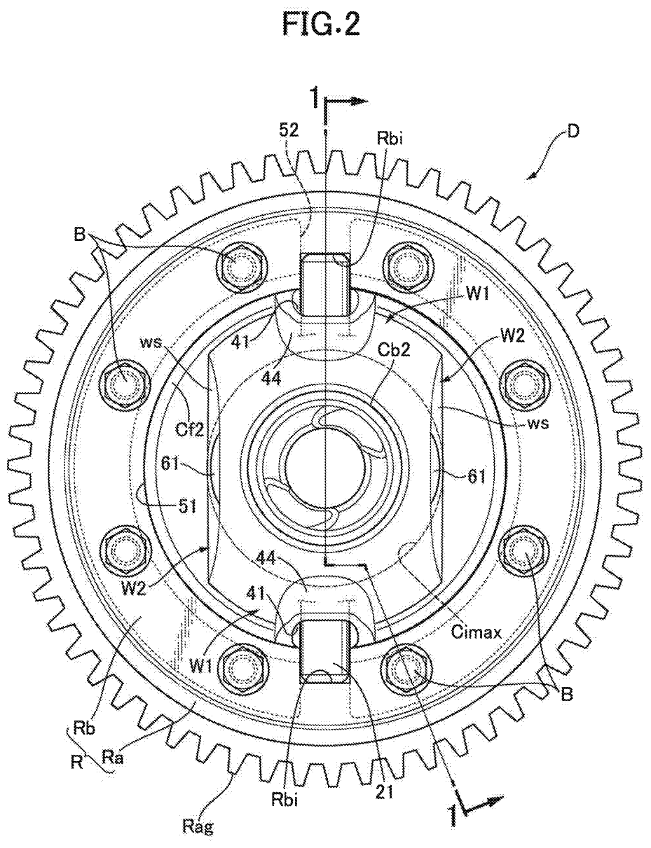

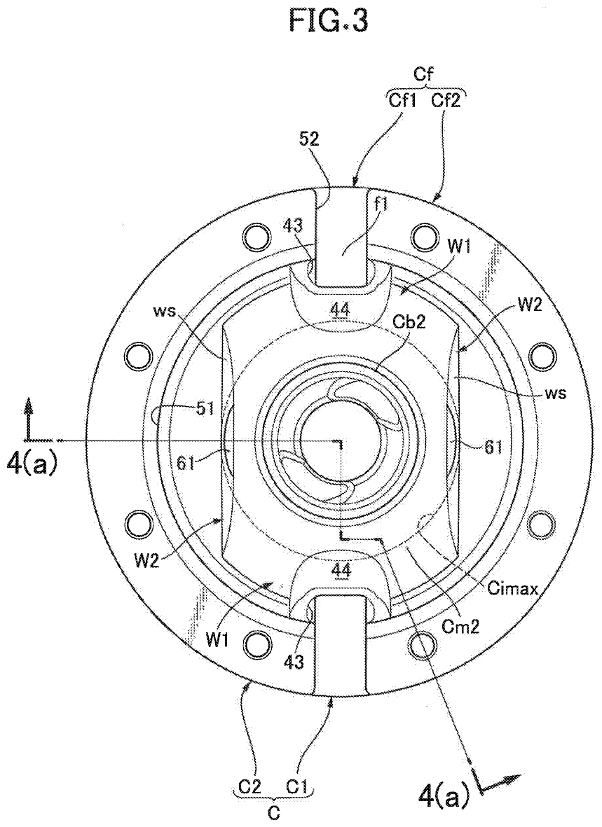

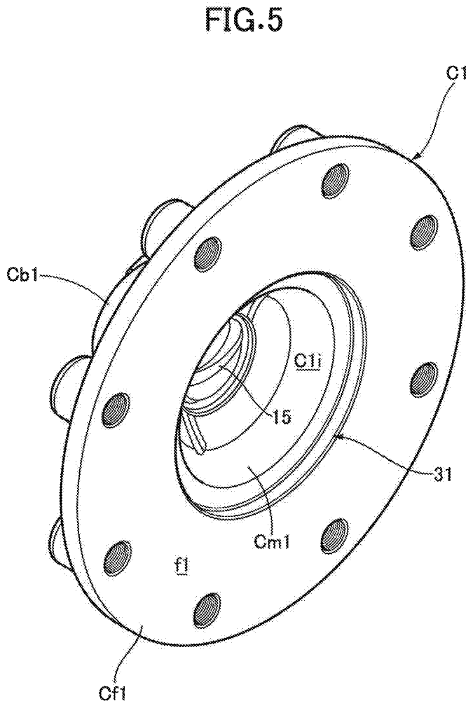

First, a first embodiment is explained by reference to FIG. 1 to FIG. 9. In FIG. 1, housed within a transmission case 9 of a vehicle (e.g. an automobile) is a differential device D that distributes and transmits power from a power source (e.g. a vehicle-mounted engine), which is not illustrated, between left and right axles 11 and 12. The differential device D includes a differential case C and a differential mechanism 20 disposed within the differential case C.

The differential case C is dividedly formed from left and right first and second case half bodies C1 and C2 detachably joined to each other via mating faces f1 and f2 on open end faces thereof.

The left and right first and second case half bodies C1 and C2 each include main body parts Cm1 and Cm2 that are formed into a substantially hemispherical shape, bearing bosses Cb1 and Cb2 that are integrally and connectedly provided on axially outside parts of the main body parts Cm1 and Cm2 and extend in the axial direction, and flange half bodies Cf1 and Cf2 that are formed integrally with outer peripheral parts of the main body parts Cm1 and Cm2 so as to face outward in the radial direction and extend in a circumferential direction with a first axis X1 as a center.

The left and right bearing bosses Cb1 and Cb2 are supported on the transmission case 9 via bearings 13 and 14 on the outer peripheral side thereof so that they can rotate around the first axis X1. Furthermore, the left and right axles (drive shafts) 11 and 12 are each rotatably fitted into inner peripheral faces of the left and right bearing bosses Cb1 and Cb2, and helical grooves 15 and 16 (see FIG. 1) for drawing in lubricating oil are provided therein. The helical grooves 15 and 16 are capable of exhibiting a screw pump action via which lubricating oil within the transmission case 9 is fed into the differential case C accompanying relative rotation between the bearing bosses Cb1 and Cb2 and the axles 11 and 12, and are one example of lubricating oil introduction means of the present invention.

The first and second case half bodies C1 and C2 are detachably joined, via a plurality of bolts B, which are described later, in a state in which mutually opposing open end faces of the left and right main body parts Cm1 and Cm2 are abutted against each other and opposing side faces of the left and right flange half bodies Cf1 and Cf2 are superimposed on one another. The left and right flange half bodies Cf1 and Cf2 are superimposed on one another to form a flange part Cf on the outer periphery of the differential case C, and in such a superimposed state the two flange half bodies Cf1 and Cf2, along with a ring gear R, are fastened together by the plurality of bolts B.

The ring gear R meshes with for example a drive gear 8 as an output part of a transmission device connected to the engine. The rotational driving force from the drive gear 8 is thereby transmitted to a pinion shaft 21 and the differential case C via the ring gear R.

The ring gear R includes in this embodiment a rim portion Ra that has a helical gear-shaped tooth portion Rag on the outer periphery, and a ring plate-shaped spoke part Rb that integrally protrudes from an inner peripheral face of the rim portion Ra. The spoke part Rb is concentrically fitted onto an annular step part 51 provided on an outside face of the second flange half body Cf2, and the fitted state is maintained by the plurality of bolts B, which extend through the spoke part Rb and the second flange half body Cf2 and are screwed into and secured to the first flange half body Cf1.

In FIG. 1, the tooth portion Rag is illustrated as a cross section along the line of teeth in order to simplify the illustration.

The differential mechanism 20 includes the pinion shaft 21, which is disposed on a second axis X2 orthogonal to the first axis X1 in a center part of the differential case C and is supported on the differential case C, a pair of pinion gears 22 and 22 rotatably supported on the pinion shaft 21, and left and right side gears 23 and 23 meshing with each of the pinion gears 22. The left and right side gears 23 and 23 function as output gears of the differential mechanism 20, and inner end parts of the left and right axles 11 and 12 are spline fitted into inner peripheral faces of the side gears 23 and 23.

Back faces of the pinion gear 22 and the side gear 23 are rotatably supported on an inner face Ci of the differential case C via a pinion washer 25 and a side gear washer 26. In the present embodiment, the inner face Ci of the differential case C is illustrated as being spherical, but this may be a tapered face or a flat face orthogonal to the first axis X1 or the second axis X2.

The pinion shaft 21 has its intermediate part inserted into a shaft hole 40, which is described later, of the differential case C and has opposite end parts engaged with an engagement recess part Rbi provided at an inner peripheral end of the ring gear R (that is, an inner peripheral face of the spoke Rb), thus preventing it from disengaging from the shaft hole 40.

The rotational driving force transmitted from the ring gear R to the pinion shaft 21 via the engagement recess part Rbi is distributed and transmitted between the left and right axles 11 and 12 via the differential mechanism 20 while allowing differential rotation. Since the power distribution function of the differential mechanism 20 is conventionally known, further explanation is omitted.

The first and second case half bodies C1 and C2 have an annular recess part 31 and an annular projecting part 32 that are concentrically fitted together on the first axis X1 on one and the other of the mating faces f1 and f2 of the two case half bodies C1 and C2.

In the present embodiment, the open end face of the first case half body C1, that is, the mating face f1 with the second case half body C2, is formed into a plane orthogonal to the first axis X1 from an end face of a large diameter end part of the main body part Cm1 of the first case half body C1 and an inside face of the flange half body Cf1 that is continuously flush with the end face. The annular recess part 31 is formed on a radially inner end part of the mating face f1 and is recessed from the mating face f1 by being stepped outward in the axial direction (leftward in FIG. 1). The annular recess part 31 opens not only on the mating face f1 but also on the inner face Ci of the differential case C (the first case half body C1).

On the other hand, the open end face of the second case half body C2, that is, the mating face f2 with the first case half body C1, is formed into a plane orthogonal to the first axis X1 from an end face of a large diameter end part of the main body part Cm2 of the second case half body C2, and an inside face of the flange half body Cf2 that is continuously flush with the end face. The annular projecting part 32 is formed on a radially inner end part of the mating face f2 and protrudes from the mating face f2 by being stepped outward in the axial direction (leftward in FIG. 1). An inner peripheral face of the annular projecting part 32 forms part of the inner face Ci of the differential case C (the second case half body C2).

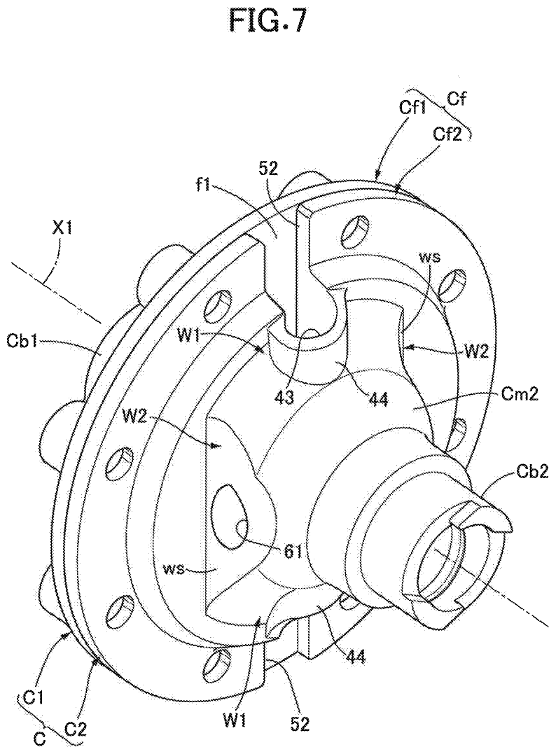

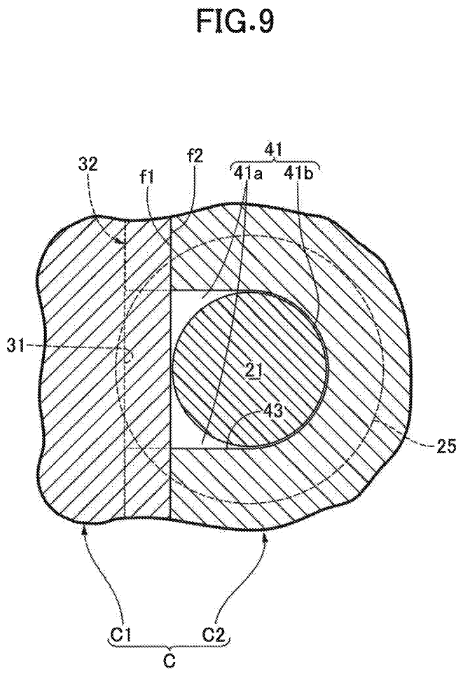

The shaft hole 40, into which the pinion shaft 21 is inserted, is formed between the mating faces f1 and f2 of the first and second case half bodies C1 and C2. The shaft hole 40 is formed, as shown in for example FIG. 7 and FIG. 9, from a U-shaped cross section groove part 43 that is recessed in the mating face f2 on the second case half body C2 side in order for the pinion shaft 21 to be inserted therethrough and supported thereon, and the mating face f1 on the first case half body C1 side formed from a plane blocking an open face of the groove part 43. The groove part 43 is one example of a pinion shaft insertion support part that is provided on one case half body (second case half body C2) and has opposite end parts of the pinion shaft 21 inserted into and supported thereon.

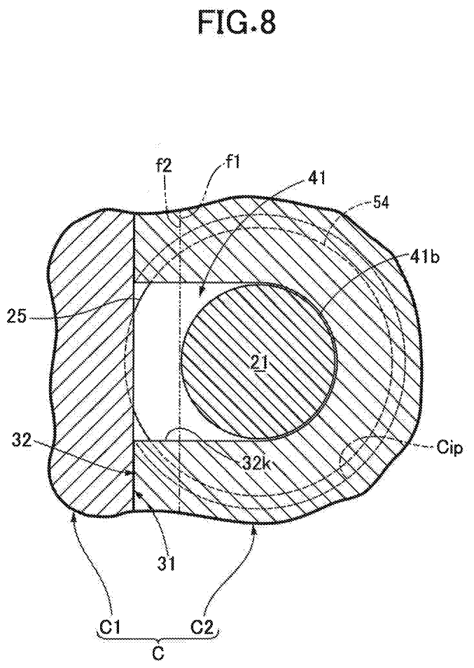

In the present embodiment, as shown in FIG. 8 and FIG. 9, a clearance 41b is provided between the shaft hole 40 and the pinion shaft 21, the clearance 41b allowing the pinion shaft 21 to move slightly in the axial direction (that is, a direction along the first axis X1) within the shaft hole 40. A setting in which such a clearance 41b is not provided is also possible.

A semicylindrical boss part 44 covering a back face side of the groove part 43 with sufficient thickness is integrally and projectingly provided on an outside face of the second case half body C2 so as to correspond to the groove part 43. The boss part 44 terminates at a root portion of the flange half body Cf2, and a cutout part 52 that is open on the radially outer side is formed in the flange half body Cf2 at a position connected to the radially outer end of the boss part 44 (and consequently the groove part 43). The cutout part 52 makes an outer peripheral face of opposite end parts of the pinion shaft 21 be exposed to the outside of the differential case C. The arrangement may be such that, without providing the boss part 44, only the groove part 43 is recessed in the second case half body C2.

Due to the groove part 43 forming the shaft hole 40 having a U-shaped cross section and the mating face f1 being a plane, a clearance space 41 extending along the pinion shaft 21 is formed between an inner face of the shaft hole 40 and an outer peripheral face of the pinion shaft 21. The clearance space 41 includes the axial clearance 41b and a pair of corner-corresponding space portions 41a formed so as to correspond to two flat inside faces of the groove part 43 and the mating face f1 orthogonal thereto.

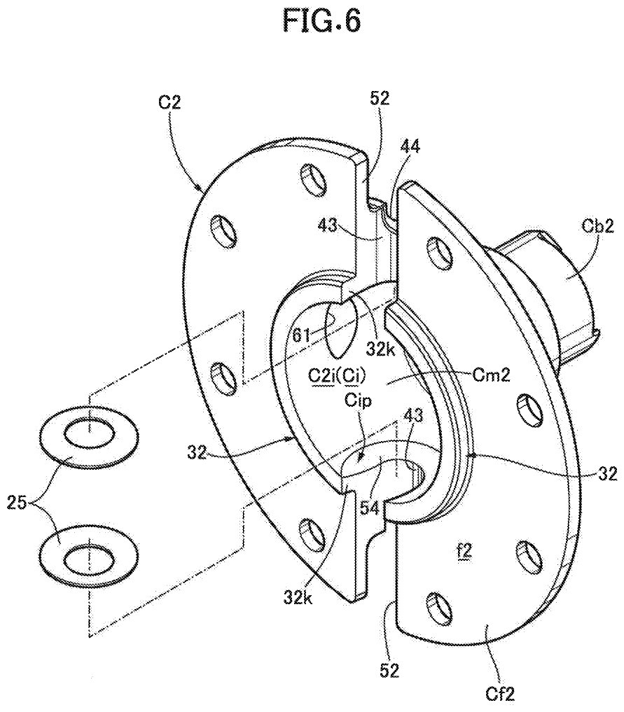

As shown in FIG. 6, FIG. 8 and FIG. 9, the annular projecting part 32 has a partial cutout in the peripheral direction at a position corresponding to the groove part 43 (pinion shaft 21), the cutout portion 32k allowing the pinion shaft 21 to be smoothly inserted into the groove part 43. A pinion support face Cip supporting, via the pinion washer 25, a back face of the pinion gear 22 around the second axis X2 is formed on the spherical inner face Ci of the differential case C so as to be slightly recessed.

With regard to the first and second case half bodies C1 and C2, inner peripheral faces C1i and C2i forming the inner face Ci of the differential case C are formed by turning in which a rotational axis CL of a material to be machined is made to coincide with the first axis X1. In particular, the second case half body C2 has a specific wall part W2 on which the position (e.g. radial position) of an outside face ws is determined so that an oil hole 61 extending between the interior and the exterior of the second case half body C2 is formed by the turning.

More specifically, the second case half body C2 includes a pair of first wall parts W1 arranged on the second axis X2 with a gap therebetween and each integrally having the groove part 43 (boss part 44) as a pinion shaft insertion support part having the opposite end parts of the pinion shaft 21 inserted into and supported thereon, and the second wall part W2, which is present between the pair of first wall parts W1 in the peripheral direction and provides an integral connection therebetween. In the first embodiment, the first wall part W1 is formed into an arc shape extending in the circumferential direction with the first axis X1 as a center, and the boss part 44 is formed integrally with a middle part in the peripheral direction of the first wall part W1 so as to bulge. On the other hand, with regard to the second wall part W2, the outside face ws is formed into a plane shape substantially parallel to the pinion shaft 21, and the oil hole 61 is provided in a middle part in the peripheral direction of the second wall part W2. The second wall part W2 corresponds to the specific wall part.

Within a predetermined axial region A of the second case half body C2 where the oil hole 61 is provided, the first wall part W1 and the second wall part W2 are set so that at the same positions in the axial direction where their inner peripheral faces are successively subjected to the turning, the radial distance of a material to be machined from the rotational axis CL to the outside face ws of the second wall part W2 is shorter than the radial distance from the rotational axis CL to the inner peripheral face of the first wall part W1.

In other words, the shape and position of the outside face ws of the second wall part W2 in particular are set so as to be relatively close to the rotational axis CL (that is, compared with an outside face of the first wall part W1) so that at the same positions in the axial direction of the first wall part W1 and the second wall part W2, the radial distance from the rotational axis CL up to the outside face ws of the second wall part W2 is shorter than the radial distance up to the inner peripheral face of the first wall part W1.

Therefore, when the inner peripheral faces of the first wall part W1 and the second wall part W2 are successively subjected to turning within the predetermined axial region A, as described later the inner peripheral faces of the first wall part W1 and the second wall part W2 are each formed as part of the inner peripheral face C2i of the second case half body C2, and in particular the oil hole 61 extending radially through part of the second wall part W2 (a middle part in the peripheral direction) and providing communication between the interior and the exterior of the second case half body C2 is formed.

The operation of the embodiment is now explained.

The first and second case half bodies C1 and C2 of the differential case C are each integrally formed (e.g. forge-formed, cast-formed) from a metal material (e.g. aluminum, an aluminum alloy, cast iron, etc.), each part of the first and second case half bodies C1 and C2 is subjected to machining as appropriate subsequent to forming, and a final product (the first and second case half bodies C1 and C2) is obtained by finishing.

In this case, the machining includes turning applied to the inner peripheral faces C1i and C2i of the first and second case half bodies C1 and C2 (in particular, turning in which the rotational axis CL of the material to be machined is made to coincide with the first axis X1).

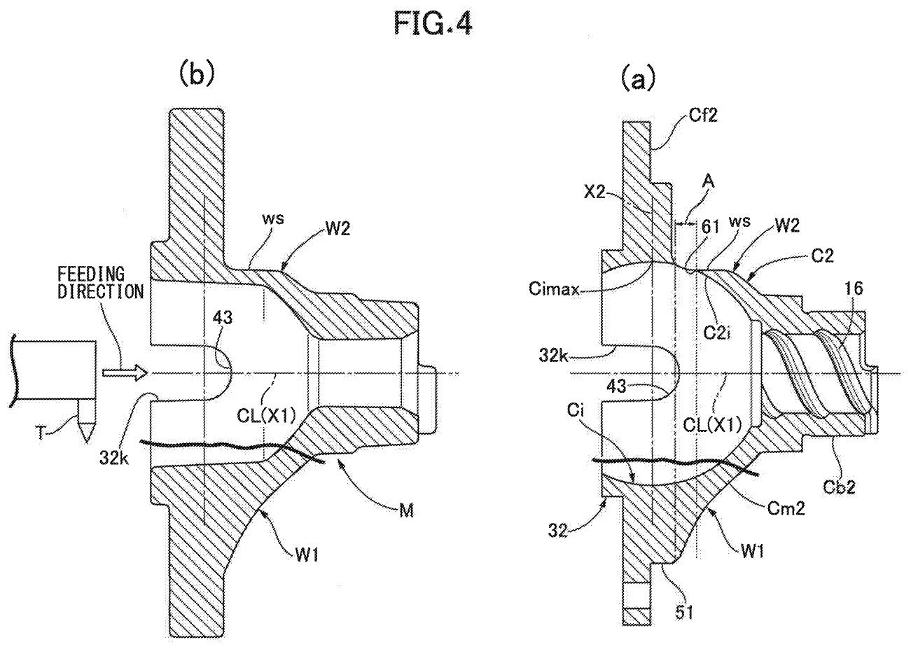

For example, FIG. 4 (b) shows one example of a hollow second case half body material M prior to machining of the second case half body C2. The outer shape of the second case half body material M is formed (e.g. forge-formed) in a shape substantially close to the final outer shape of the second case half body C2, and at the same time as the forming, some of the portions (e.g. the groove part 43-equipped boss part 44, the cutout part 52, the outer surface of the first and second wall parts W1 and W2, etc.) that are to be the main body part Cm2 and the flange half body part Cf2 of the second case half body C2 are formed. An inner peripheral face and an outer peripheral face of a portion that is to be the second boss part Cb2 are also subjected to groove forming for the helical groove 16 or other machining as appropriate.

The turning for forming the inner peripheral face C2i of the second case half body C2 is carried out while gradually feeding a turning tool T (e.g. a cutting tool, see FIG. 4(b)) of a lathe along the predetermined rotational axis CL into the material to be machined, that is, the second case half body material M, through the open end thereof in a state in which the second case half body material M is rotated around the rotational axis CL. In this case, the radial distance between the blade edge of the turning tool T and the rotational axis CL is set so that the radial distance changes slightly so as to be commensurate with a small amount of feed in the axial direction of the turning tool T in order to make the turned face spherical.

The second case half body material M, which has completed the turning, has substantially the same shape and structure as those of the second case half body C2 as a final product, and this is subjected to a final finishing process.

The second case half body C2 thus obtained includes the pair of first wall parts W1, which integrally have the groove part 43 (and consequently the boss part 44) as a pinion shaft insertion support part, and the second wall part W2, which is present between the pair of first wall parts W1 in the peripheral direction and provides an integral connection therebetween. With regard to the first wall part W1 and the second wall part W2, at the same positions in the axial direction where the inner peripheral faces thereof are successively subjected to the turning, the radial distance from the rotational axis CL of the material to be machined up to the outside face ws of the second wall part W2 is set to be shorter than the radial distance from the rotational axis CL up to the inner peripheral face of the first wall part W1.

As a result, when the inner peripheral faces of the first wall part W1 and the second wall part W2 are successively subjected to the turning, in the first wall part W1 and the second wall part W2, each inner peripheral face is formed into a spherical shape as part of the inner peripheral face C2i of the second case half body C2, in particular in the second wall part W2, part thereof (that is, a middle part in the peripheral direction) is penetrated to thus form the oil hole 61, and the oil hole 61 provides communication between the interior and the exterior of the second case half body C2.

When assembling the differential device D, in a state in which the first and second case half bodies C1 and C2 are separated from each other, while setting each constituent element of the differential mechanism 20, that is, the pinion shaft 21, the pinion gear 22 and the side gear 23 therebetween, the mating faces f1 and f2 of the first and second case half bodies C1 and C2 are superimposed on one another. In this process, fitting the annular recess part 31 and the annular projecting part 32 of the mating faces f1 and f2 together enables the two case half bodies C1 and C2 to be correctly and concentrically disposed.

Subsequently, an inner peripheral end part of the spoke part Rb of the ring gear R is concentrically fitted onto the annular step part 51 on the side face of the second case half body C2, and the ring gear R and the flange half bodies Cf1 and Cf2 are fastened together by means of the plurality of bolts B. In this collectively fastened state, the engagement recess part Rbi on the inner periphery of the spoke part Rb of the ring gear R is engaged with opposite ends of the pinion shaft 21, thus preventing the pinion shaft 21 from falling out of the shaft hole 40 and linking the ring gear R and the pinion shaft 21 so that torque can be directly transmitted.

The first and second bearing bosses Cb1 and Cb2 of the differential case C housing the differential mechanism 20 are rotatably supported on the transmission case 9 via the bearings 13 and 14, and the inner end parts of the left and right axles 11 and 12 are further inserted into the first and second bearing bosses Cb1 and Cb2 and spline fitted into the inner periphery of the left and right side gears 23 and 23, thus completing assembly of the differential device D onto the automobile.

When the differential device D exhibits a differential function, the left and right bearing bosses Cb1 and Cb2 of the differential case C and the axles 11 and 12 undergo relative rotation, and accompanying this the helical grooves 15 and 16 on the inner periphery of the bearing bosses Cb1 and Cb2 exhibit a screw pump action that feeds lubricating oil within the transmission case 9 into the differential case C. Even if the differential case C has no window hole, sufficient lubricating oil outside the differential case C can thereby be introduced to the differential mechanism 20 within the differential case C.

In accordance with the turning of the inner peripheral face C2i of the second case half body C2, part of the second wall part W2 is penetrated in the radial direction, and the oil hole 61 providing communication between the interior and the exterior of the second case half body C2 is formed. Part of the lubricating oil that has been introduced into the differential case C and lubricated each part of the differential mechanism 20 is thereby discharged by means of centrifugal force to the outside of the differential case C via the oil hole 61, which is present in the inner peripheral face C2i of the second case half body C2, in particular close to the maximum diameter part Ci_{MAX} of the differential case inner face Ci. This enables lubricating oil within the differential case C to be smoothly discharged outside the differential case C even without specially providing the differential case C with a large window, and since oil that lubricates the differential mechanism 20 can be made to flow efficiently and exchanged between the interior and the exterior of the differential case C, the function of lubricating each part of the differential mechanism 20 is well exhibited; not only does this contribute to prevention of seizure of parts of the differential mechanism 20, but it is also possible to prevent a large amount of metal wear powder from remaining within the differential case C, thus enabling smooth operation of the differential mechanism 20 and improvement of durability to be achieved.

Moreover, since the oil hole 61 as a lubricating oil discharge path to the outside of the differential case C is automatically formed in a specific wall part, that is, in the second wall part W2, accompanying turning of the inner peripheral face C2i of the second case half body C2, it is totally unnecessary to carry out an additional process for specially providing the oil hole 61, and since the discharge path structure for lubricating oil in the differential case C is simplified, the total cost can be greatly reduced.

The inner peripheral face of the first wall part W1 of the first embodiment is formed into a spherical shape by the turning, and as clearly shown in FIG. 1 and FIG. 4 (a) the maximum diameter part Ci_{MAX} of the spherical surface is biased inward in the axial direction from the open end face of the first wall part W1. The second flange half body Cf2 (and consequently the flange part Cf) and the groove part 43 (that is, the pinion shaft insertion support part) are disposed at positions where they overlap the maximum diameter part Ci_{MAX} when viewed on a projection plane orthogonal to the second axis X2, and the oil hole 61 is disposed so as to be adjacent to the second flange half body Cf2 on the outer side in the axial direction thereof. This enables the oil hole 61 to be disposed in a part relatively close to the maximum diameter part Ci_{MAX} of the inner peripheral face of the first wall part W1, thus enabling oil to be efficiently discharged from the oil hole 61 by means of centrifugal force. With the oil hole 61 being disposed in such a manner, since the oil hole 61 is disposed so as to be adjacent to the flange part Cf (the second flange half body C2f) on the outer side in the axial direction, it is possible to form the oil hole 61 so as to extend through the second case half body C2 without problems and without interfering with the second flange half body Cf2.

When the second case half body material M is molded by forging, a draft angle is formed on an inner peripheral face prior to machining (see FIG. 4 (b)). That is, prior to machining, the internal diameter of the second case half body material M has a maximum radial dimension at the opening on the mating face f2 side, and the radial dimension decreases in going away from the mating face f2. When a spherical inner peripheral face of the second case half body material M is subjected to machining (turning) so that the flange part Cf2 has the maximum diameter part Ci_{MAX}, among regions adjacent to the flange part Cf2 on the outer side in the axial direction, a region on the second boss part Cb2 side has a larger machining allowance. Therefore, in the present embodiment, the oil hole 61 is formed in the region having a large machining allowance. By so doing, with regard to the second case half body material M, the oil hole 61 can be formed without problems by machining (turning) its inner peripheral face while ensuring the thickness necessary for good forge-forming.

The pinion shaft insertion support part of the differential case C of the first embodiment is formed from the groove part 43, which is formed integrally with the second case half body C2 and has an open face opposing the first case half body C1, and sandwiches the pinion shaft 21 between itself and the first case half body C1 with the clearance 41b in a direction along the first axis X1, and the pinion shaft 21 is engaged with the inner peripheral part of the ring gear R joined to the flange part Cf so as to be capable of transmitting torque.

This eliminates the necessity for subjecting the second case half body C2 to a process of forming a hole or making a groove a complicated shape in order to provide a pinion shaft insertion support part, the cost can be reduced, and the effect from the cost reduction is particularly advantageous in terms of avoiding complications of a mold when the second case half body C2 is formed by forging. Moreover, with the synergistic effect of the ability to carry out direct transmission of rotational torque from the inner peripheral part (engagement recess part Rbi) of the ring gear R toward the pinion shaft 21 side and the presence of the clearance 41b in the axial direction between the groove part 43 and the pinion shaft 21, the burden on the first and second case half bodies C1 and C2 at the time of transmission can be lightened, and this is particularly advantageous when the first and second case half bodies C1 and C2 are formed from a relatively low rigidity material (e.g. aluminum, an aluminum alloy, etc.).

Furthermore, in the first embodiment, since the mating face f1, opposing the second case half body C2, of the first case half body C1 is formed into a plane orthogonal to the first axis X1, and the open face of the groove part 43 (pinion shaft insertion support part) is closed by the plane, the machining step can be further simplified, thus further reducing the cost.

In particular, since the outside face ws of the second wall part W2 of the first embodiment is a plane substantially parallel to the pinion shaft 21, it is possible to form with good balance the oil hole 61 in each of the pair of second wall parts W2 and W2, which have the outside face ws substantially parallel to the pinion shaft 21, and it is also possible to discharge oil via the oil hole 61 with good balance. Moreover, since the second case half body C2 has no mass on the radially outer side than the outside face ws of the pair of second wall parts W2 and W2 and is made slim accordingly, it is possible to ensure the rigidity necessary for the second case half body C2 (in particular, the rigidity with which the pinion shaft 21 is supported) while lightening the weight of the second case half body C2.

### Second Embodiment

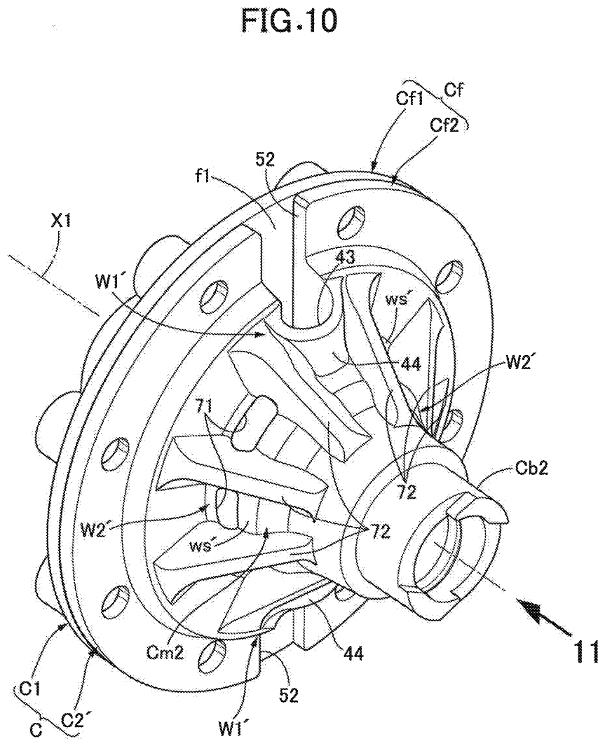

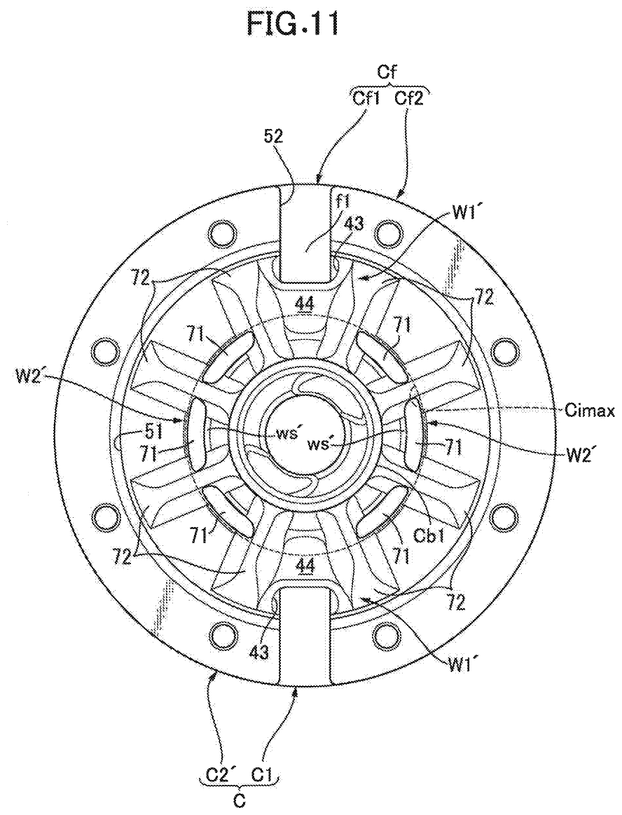

FIG. 10 and FIG. 11 show a second embodiment of the present invention. In the second embodiment also, a second case half body C2′ includes a pair of first wall parts W1′ each having the groove part 43 (pinion shaft insertion support part) having opposite end parts of the pinion shaft 21 inserted into and supported thereon, and a second wall part W2′ positioned between the pair of first wall parts W1′ in the peripheral direction, the second wall part W2′ corresponding to a specific wall part. As in the first embodiment, with regard to the first wall part W1′ and the second wall part W2′, at the same positions in the axial direction where each inner peripheral face is successively subjected to the turning, the radial distance from the rotational axis CL of a material to be machined up to an outside face ws′ of the second wall part W2′ is set to be shorter than the radial distance from the rotational axis CL up to the inner peripheral face of the first wall part W1′.

With regard to the second wall part W2′ of the second embodiment, unlike the first embodiment, the outside face ws′ extends while curving in an arc shape in the peripheral direction. Formed in the second wall part W2′ by means of turning, in which the rotational axis CL of the material to be machined is made to coincide with the first axis X1, are a plurality of oil holes 71 extending between the interior and the exterior of the second wall part W2′ and arranged in the peripheral direction, and also provided integrally with the second wall part W2′ are a plurality of reinforcing ribs 72 disposed between adjacent oil holes 71 and extending in the axial direction and the radial direction.

The arrangement is otherwise basically the same as that of the first embodiment, and constituent elements corresponding to the constituent elements of the first embodiment are denoted by the same reference numerals and symbols, further explanation being omitted.

In accordance with the second embodiment, not only can the same operational effects as those of the first embodiment be exhibited, but the following operational effects can also be achieved.

That is, in the second embodiment, due to the plurality of oil holes 71 being disposed in the peripheral direction in a dispersed manner, lubricating oil can be discharged more smoothly. Furthermore, even when the plurality of oil holes 71 are arranged side by side in this way, degradation of strength caused thereby can be suppressed effectively by means of the plurality of reinforcing ribs 72 present between adjacent oil holes 71 in the peripheral direction and extending in the axial direction and the radial direction.

Embodiments of the present invention are explained above, but the present invention is not limited to the embodiments and may be modified in a variety of ways as long as the modifications do not depart from the subject matter.

For example, the embodiments illustrate a case in which the differential device D is applied to a differential device for a vehicle, but in the present invention the differential device D may be applied to various machines and devices other than a vehicle.

Furthermore, the embodiments illustrate a case in which the flange part Cf of the differential case C and the ring gear R are joined by means of the plurality of bolts B, but in the present invention the flange part Cf and the ring gear R may be joined by means of welding (e.g. laser welding, electron beam welding, etc.).

Moreover, the embodiments illustrate a case in which the tooth portion Rag of the ring gear R has a helical gear shape, but the ring gear of the present invention is not limited to the embodiment and may be for example a bevel gear, a hypoid gear, a spur gear, etc.

Furthermore, the embodiments illustrate a case in which the shaft hole 40 is formed from the mating face f1 (plane) of the one case half body C1 and the groove part 43 in the mating face f2 of the other case half body C2, but a groove part may also be recessed in the mating face f1 side so as to oppose the groove part 43 to thus form the shaft hole 40 between the groove parts of the two mating faces f1 and f2.

Moreover, the embodiments illustrate, as one example of the lubricating oil introduction means, the helical grooves 15 and 16 for drawing in lubricating oil provided in the inner peripheral faces of the bearing bosses Cb1 and Cb2, but the lubricating oil introduction means is not limited to the embodiments. For example, in addition to or instead of the helical grooves 15 and 16, a lubricating oil passage or a helical groove as lubricating oil introduction means may be provided in the axles 11 and 12 or a side gear boss extending lengthwise on a back face of the side gear 23 and extending outside the differential case C, etc. Alternatively, means for issuing or dripping lubricating oil from a ceiling part or a side wall part of the transmission case 9 toward an outer end opening of the groove part 43 (pinion shaft insertion support part) may be the lubricating oil introduction means.

Furthermore, the first embodiment illustrates a case in which the outside face ws of the second wall part W2 is a plane substantially parallel to the pinion shaft 21, but the outside face ws of the second wall part W2 is not necessarily a plane. For example, the outside face ws may be a shape in which a plane and a curved face are combined, or the entire outside face ws may be a curved face that is concavely curved toward the pinion shaft 21.

1. A differential device comprising a hollow differential case that is capable of rotating around a first axis,
a differential mechanism that is housed within the differential case,
lubricating oil introduction means that is capable of introducing lubricating oil from outside into the differential case, and
a ring gear that is joined to a flange part on an outer periphery of the differential case and meshes with a drive gear connected to a power source,
the differential mechanism having a pinion shaft that is disposed on a second axis orthogonal to the first axis and is supported on the differential case, a pinion gear that is capable of rotating around the pinion shaft, and a pair of side gears that mesh with the pinion gear and are capable of rotating around the first axis,
wherein the differential case comprises a pair of case half bodies that are joined to each other in a state in which open ends thereof oppose each other in an axial direction,
an inner peripheral face of at least one case half body is formed by turning while a rotational axis of a material to be machined is made to coincide with the first axis, and said one case half body has a wall part in which the position of an outside face thereof is determined so that an oil hole extending between an interior and an exterior of said one case half body is formed by said turning.

2. A differential device comprising a hollow differential case that is capable of rotating around a first axis,
a differential mechanism that is housed within the differential case,
lubricating oil introduction means that is capable of introducing lubricating oil from outside into the differential case, and
a ring gear that is joined to a flange part on an outer periphery of the differential case and meshes with a drive gear connected to a power source,
the differential mechanism having a pinion shaft that is disposed on a second axis orthogonal to the first axis and is supported on the differential case, a pinion gear that is capable of rotating around the pinion shaft, and a pair of side gears that mesh with the pinion gear and are capable of rotating around the first axis,
wherein the differential case comprises a pair of case half bodies that are joined to each other in a state in which open ends thereof oppose each other in an axial direction,
an inner peripheral face of at least one case half body is formed by turning while a rotational axis of a material to be machined is made to coincide with the first axis, said one case half body comprises a pair of first wall parts that each have a pinion shaft insertion support part having opposite end parts of the pinion shaft inserted into and supported thereon, and a second wall part that is positioned between the pair of first wall parts in a peripheral direction,
with regard to the first wall part and the second wall part, at the same position in the axial direction where inner peripheral faces thereof are successively subjected to said turning, a radial distance from the rotational axis up to an outside face of the second wall part is set to be shorter than a radial distance from the rotational axis up to an inner peripheral face of the first wall part, and
an oil hole is formed by said turning so as to extend through part of the second wall part, the oil hole providing communication between an interior and an exterior of said one case half body.

3. The differential device according to claim 2, wherein the inner peripheral face of the first wall part is formed by said turning into a spherical shape in which a maximum diameter part is biased further inward in the axial direction than an open end in the axial direction of the first wall part,
the flange part and the pinion shaft insertion support part are disposed at positions that overlap the maximum diameter part when viewed on a projection plane orthogonal to the second axis, and the oil hole is disposed so as to be adjacent to the flange part on an outer side in the axial direction.

4. The differential device according to claim 2, wherein the pinion shaft insertion support part is formed from a groove part that is recessed in a mating face of said one case half body that is mated with the other case half body, and sandwiches the pinion shaft between the pinion shaft insertion support part and said other case half body with a clearance in the axial direction, and
the pinion shaft is engaged with an inner peripheral part of the ring gear joined to the flange part so as to be capable of transmitting torque.

5. The differential device according to claim 2, wherein with regard to the second wall part, the outside face is a plane substantially parallel to the pinion shaft.

6. The differential device according to claim 2, wherein with regard to the second wall part, the outside face extends so as to be curved into an arc shape in the peripheral direction,
a plurality of oil holes extending between an interior and an exterior of the second wall part and arranged in the peripheral direction are formed by said turning in the second wall part, and a plurality of reinforcing ribs disposed between adjacent oil holes are provided integrally with the second wall part.

7. The differential device according to claim 3, wherein the pinion shaft insertion support part is formed from a groove part that is recessed in a mating face of said one case half body that is mated with the other case half body, and sandwiches the pinion shaft between the pinion shaft insertion support part and said other case half body with a clearance in the axial direction, and
the pinion shaft is engaged with an inner peripheral part of the ring gear joined to the flange part so as to be capable of transmitting torque.

8. The differential device according to claim 3, wherein with regard to the second wall part, the outside face is a plane substantially parallel to the pinion shaft.

9. The differential device according to claim 4, wherein with regard to the second wall part, the outside face is a plane substantially parallel to the pinion shaft.

10. The differential device according to claim 7, wherein with regard to the second wall part, the outside face is a plane substantially parallel to the pinion shaft.

11. The differential device according to claim 3, wherein with regard to the second wall part, the outside face extends so as to be curved into an arc shape in the peripheral direction,
a plurality of oil holes extending between an interior and an exterior of the second wall part and arranged in the peripheral direction are formed by said turning in the second wall part, and a plurality of reinforcing ribs disposed between adjacent oil holes are provided integrally with the second wall part.

12. The differential device according to claim 4, wherein with regard to the second wall part, the outside face extends so as to be curved into an arc shape in the peripheral direction,
a plurality of oil holes extending between an interior and an exterior of the second wall part and arranged in the peripheral direction are formed by said turning in the second wall part, and a plurality of reinforcing ribs disposed between adjacent oil holes are provided integrally with the second wall part.

13. The differential device according to claim 7, wherein with regard to the second wall part, the outside face extends so as to be curved into an arc shape in the peripheral direction,
a plurality of oil holes extending between an interior and an exterior of the second wall part and arranged in the peripheral direction are formed by said turning in the second wall part, and a plurality of reinforcing ribs disposed between adjacent oil holes are provided integrally with the second wall part.
